(19) United States
(12) Patent Application Publication
(10) Pub. No.: US 2005/0005403 A1
(43) Pub. Date: Jan. 13, 2005

(54) Water-proof structure of the pull-rod of the cabin cap

(76) Inventor: Lee-Wen Jien, Kaohsiung City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/601,626

(22) Filed: Jun. 24, 2003

(51) Int. Cl. E05B 7/00

(52) U.S. Cl. 16/415

(57) ABSTRACT

A water-proof structure of the pull rod of the cabin cap, which is mainly to concave settled a first water-proof rubber ring on the inner edge of the bottom in pivot with the pull rod main body, and to settle a plurality of water-proof rubber ring on the fixed rod beneath the first water-proof rubber ring, when the pull rod main body is inserted into the ladder typed hole in the ladder typed hole of the positioning seat, the first water-proof rubber ring on the fixed rod will be pasted tightly with the top edge of the hole, meanwhile, the other water-proof rubber ring on the fixing rod will be dislodged inside said holes. The water could be avoided to enter into the seal gap of the rod axis and the holes through such multiple layers of water-proof rubber rings to achieve the object of water-proof.

### BACKAGEGROUND OF THE INVENTION

1. Field of the Invention

This invention is a kind of water-proof structure of cabin cap pull rod, especially refer to a water-proof structure of cabin cap pull rod which utilizes the water-proof rubber ring on the fixing axis of the pull rod main body to be in cooperation with the holes in the positioning seat so that the water is not easily to enter into.

2. Description of the Prior Art

Please refer to FIG. 1, which is mainly comprised of a pull rod main body 10, positioning seat 20, ring 40 and pin 50; said pull rod main body 10 is comprised of a 101 and a fixed axis rod 102; and there settles two layers of water-proof rubber ring 60, 61 on 101, there settles a screw on a fixed axis rod 102, and there settles a hole 103 on the proper position;

When the pull rod main body 10 is inserted into the ladder typed hole 201 extended downwardly, the first water-proof rubber ring 30 of the fixed axis rod 102 is dislodged on the ladder typed holes 201, and it is tightly pasted with the inner wall of the ladder typed hole 201, next to stably connect with the pull rod main body 10 and the positioning seat 20 through the ring 40 and the pin 50.

Although the above-mentioned structure could achieve the effect of water-proof, since it will cause the water-proof rubber ring wear, tired after long term usage, next it will generate the gap, so that the water will enter into the cabin easily.

From that it is easily to be understood that the above-mentioned design is not a good design and requires to be bettered.

The inventor of this invention, after several years' study, finally invent the water-proof structure of the pull rod of the cabin cap of this invention.

### SUMMARY OF THE INVENTION

The object of the invention is to ring settled several layers of the water-proof rubber ring on the fixed axis rod of the pull rod main body, by means of this the holes of the water-proof rubber ring is in close connection with that of the positioning seat which prevents the water from entering into the water-proof structure.

Another object of this invention is to concave settle a water-proof rubber ring on the inner edge of the bottom of the pivot seat, by means of the tight cooperation of the rubber ring with the top edge of the second hole such that the water is not easily to enter from the gap of the hole which increases the usage life.

Another object of this invention is to fabricate a water-proof structure of the cabin cap pull rod which is easily to fabricate and with simple construction.

The water-proof structure of the cabin cap pull rod that could achieve the object of the invention comprises a cabin cap main body, the positioning seat, the sing and the pin; said cabin cap main body is composed of a pull rod and a fixed axis rod, the pull rod is pivoted on the pivot seat of the front end of the fixed axis rod, the inner edge on the bottom of the pivot seat there concave settled the first water-proof rubber ring, and there ring settled the second and the third water-proof water-proof rubber ring, whereas there settles the screw on the fixed axis rod, and there settles a hole on the proper position; there extends downwardly the ladder typed hollow positioning column such that there forms the first hole and the second hole wherein the top edge of the second hole is protrude extending inside the first hole;
When the pull rod main body is inserted into the ladder typed hollow positioning column, the pivot seat of said pull rod main body is installed inside the first hole, and the first water-proof rubber ring on the bottom of the pivot seat is tightly pasted with the top edge of the second hole; the second water-proof rubber ring and the third water-proof rubber ring on the fixed axis rod are installed inside the second hole and tightly pasted with the inner wall of the second hole;

the fixed axis rod of the pull rod main body could be positioned through the ring and pin to be stably connected with the positioning seat; it could prevent the water from entering into the cabin through the settlement of multiple layer of water-proof rubber ring to achieve the object of water-proof.

### BRIEF DESCRIPTION OF THE DRAWINGS

The drawings disclose an illustrative embodiment of the present invention which serves to exemplify the various advantages and objects hereof, and are as follows:

FIG. 1 is the cross-sectional view of the conventional pull rod of the cabin cap;

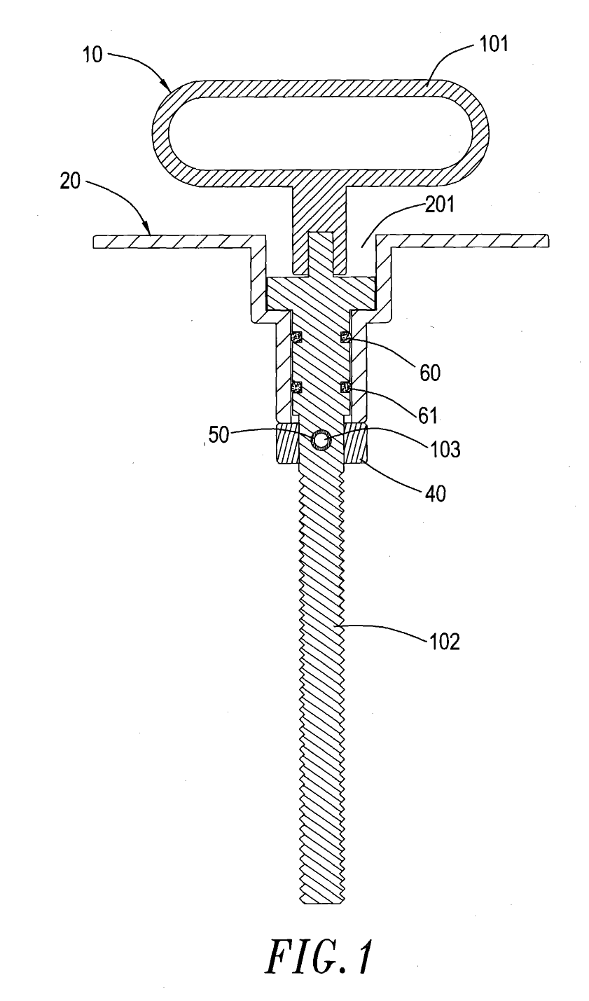

FIG. 2 is the assembly view of the water-proof structure of the pull rod of the cabin cap of this invention;

FIG. 3 is the cross-sectional view of the water-proof structure of the pull rod of the cabin cap of this invention;

FIG. 4 is the solid view of the water-proof structure of said pull rod

### DETAILED DESCRITION OF THE PREFERRED EMBODIMENT

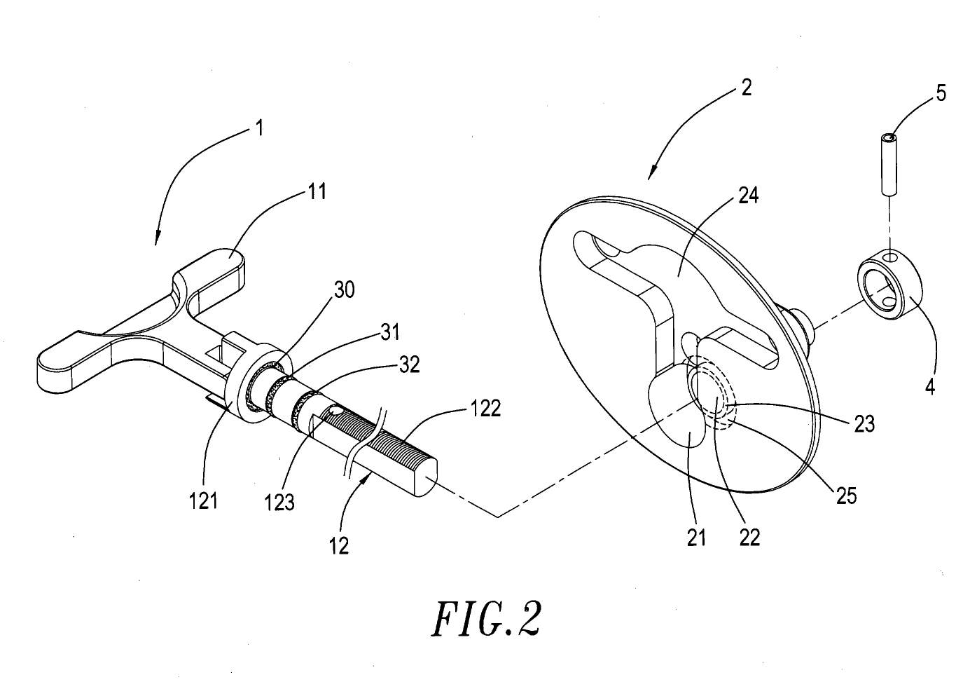

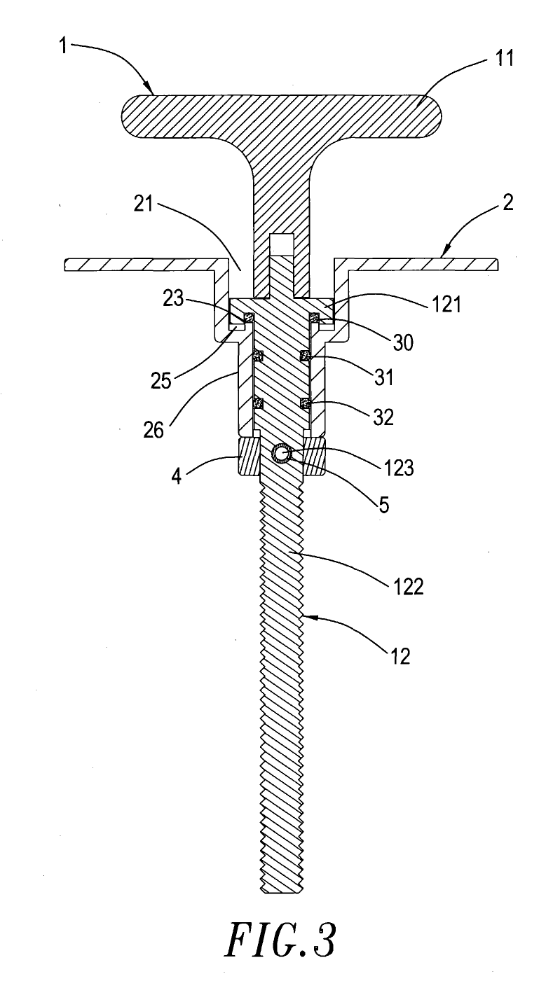

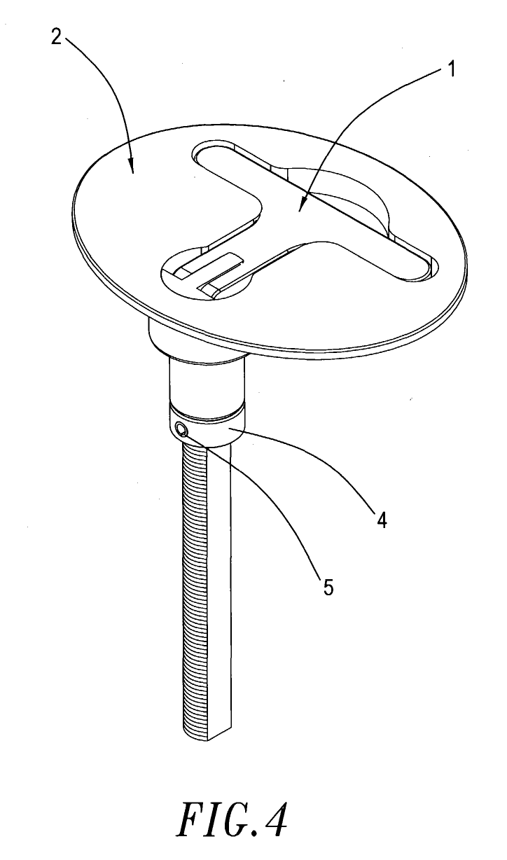

Please refer to FIG. 2-FIG. 4, the water-proof structure of the cabin cap pull rod provided by this invention is mainly comprised of a pull rod main body 1, a positioning seat 2, the ring 4 and the pin 5; said pull rod main body 1 is consisted of a pull rod 11 and a fixed axis rod 12 wherein the pull rod is pivot connected to the pivot seat 121 on the front end of the fixed axis rod 12, on the inner edge of the bottom of the pivot seat 121 there concave settles a first water-proof rubber ring, and there ring settles the second and the third water-proof water-proof rubber ring 31, 32 beneath the first water-proof rubber ring and on the fixed axis rod 12, there settles a screw 122 on the fixed axis rod 12, and there settles a hole 123 on the proper position; on said positioning seat 2 there extends downwardly a ladder typed hollow positioning column 26 so that it could form the first hole 21 and the second hole 22 wherein the diameter value of the first hole 21 is larger than that of the second hole 22, besides, the top edge of the first hole is protruding within the first hole 21 so that there generates a circular shaped groove 25 on the bottom of the first hole 21; when the water is penetrating from the gap between the pivot seat and the first hole, the water is flowing into the manger as the buffer, besides, the extra settlement of the first water-proof rubber ring makes the water unlikely to flow into reversely which effectively retard the water from entering into the cabin; and it settles a T shaped concave groove 24 on the positioning seat 2, wherein one end of the T typed concave groove 24 is in connection with the first hole 21;

When the pull rod main body 1 is inserted into the ladder typed hollow positioning column 26, the pivot seat 121 of the pull rod main body 1 is allocated within the first hole 21, wherein the first water-proof rubber ring 30 on the bottom of the pivot seat 121 is pasted on the edge of the second hole 23, meanwhile, the second water-proof rubber ring and the third water-proof rubber ring 32 on the fixed axis rod 12 is allocated within the second hole 22 and is tightly pasted with the inner wall of the second hole 22, meanwhile, by means of the turnover of the pull rod 11, the pull rod could be dislodged inside the T typed concave groove 24 of the positioning seat 2, and it positions the fixed axis rod 12 of the pull rod main body 1 and is stably connected with the positioning seat 2 by the ring 4 and the pin 5, by means of the cooperation of the first water-proof rubber ring 30 and the edge of the second hole 23 which could prevent the other water-proof rubber being tired due to long period of usage and further causes a gap such that the water flows into the cabin to achieve better water-proof effects.

The water-proof structure of the pull rod provided by this invention has the following advantages in comparison with the other conventional objects:

1. This invention could easily to achieve the object of water-proof by the cooperation of the multiple-layer water-proof rubber settled on the cabin cap pull rod with the ladder typed hollow positioning column of the positioning seat.

2. This invention is to concave settle a water-proof rubber ring on the inner edge of the bottom of the pivot seat and in cooperative with the edge of the second hole so that the water is not easily to penetrate into it which achieves better water-proof results.

3. This invention could be easily to have more complete water-proof effect for the through simple structure and process.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A water-proof structure of the pull rod of the cabin cap comprising:
a pull rod main body, which is consist of a pull rod and a fixed axis rod, wherein a pivot seat extends from the front upper side of said fixed axis rod, and said pull rod connected on said pivot seat, several layers of water-proof rubber ring setting on said fixed axis rod beneath the pivot seat, and there settles a screw on the fixed axis rod, and there also settles a hole on the proper position;
a positioning seat, there extends downwardly a ladder shaped hollow positioning column which makes said position seat form a first hole and a second hole, besides, the edge of the second hole being protrude outwardly within the first hole to generate a groove on the bottom of the first hole;
thereof comprising steps of: settling said groove on the inner edge of the bottom of said pivot seat of said pull rod main body, and settling a water-proof rubber ring in the groove; the pivot seat dislocated within the first hole upon the pull rod main body inserting into the ladder typed hollow positioning column, wherein the water-proof rubber ring on the bottom of the pivot seat is tightly pasted with the top edge of the second hole, next to position the fixed axis rod of the pull rod main body through the ring and the pin to tie in the positioning seat with stable.

2. The water-proof structure of the pull rod of the cabin cap as mentioned in claim 1, when the pull rod main body inserting into the ladder typed hollow positioning column of the positioning seat, the water-proof rubber ring on the fixed axis rod being dislodged within the second hole and tightly pasted with the inner wall of the second hole.

3. The water-proof structure of the pull rod of the cabin cap as mentioned in claim 1, wherein there settles a plurality of water-proof rubber ring on the fixed axis rod.

4. The water proof structure of the pull rod of the cabin cap as mentioned in claim 1, wherein there settles a T typed concave groove on said positioning seat, and one end of said groove interconnecting with the first hole which could allocate the pull rod within the groove through the turnover of the pull rod.
